(19) United States
(12) Patent Application Publication
(10) Pub. No.: US 2008/0007081 A1
(43) Pub. Date: Jan. 10, 2008

(54) Locking apparatus and glove box

(75) Inventors: Minoru Shibata, Aichi-ken (JP); Shinji Kumazawa, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/723,433

(22) Filed: Mar. 20, 2007

(30) Foreign Application Priority Data
Mar. 22, 2006 (JP) P-2006-078091

(51) Int. Cl. B60R 7/06; B65D 55/14

(52) U.S. Cl. 296/37.12; 70/158

(57) ABSTRACT

A locking canceling operation is made to be performed using as a driving force a restoring force produced when a deformable canceling member made of a shape memory alloy is heated to restore its memorized shape.

### BACKGROUND OF THE INVENTION

1. Field of the Invention

The present invention relates to a locking apparatus for locking an openable and closable lid element such as a lid, a door or the like which can be opened and closed in a closed position to thereby restrict an opening operation of the lid element and a glove box of a vehicle which is provided with the locking apparatus.

2. Related Art

A glove box provided in an instrument panel of a vehicle has a storage portion for storing therein an article to be stored, and a lid element is provided at an opening in the storage portion to cover and uncover the opening. The lid element is locked by a locking element in such a state that the lid element covers the opening, whereby opening the lid element is restricted. In addition, the lock of the lid element by the locking element is manually canceled through operating an operation element provided on the lid element (for example, JP-A-2005-29075).

In performing the manual operation to open the glove box in the way described above, however, since the operation becomes troublesome, conventionally, as in a glove box described in, for example, JP-A-63-83363U, a configuration is also proposed in which a solenoid is used as an actuator for driving the locking portion in such a manner that the solenoid is energized by operating a canceling switch or the like, so as to cancel the lock of the lid element by the locking element.

In a glove box as in JP-A-63-83363U in which the locking by the locking element is canceled by the solenoid, however, large operation noise is produced when the solenoid is put in operation, which is not preferable. In recent years, in particular, on vehicles, quietness in the passenger compartment is regarded as one of important aspects, and hence, the production of even slight noise is desired to be suppressed to as low a level as possible. In addition, the problem that the large operation noise is produced at the time of unlocking can occur not only on the locking apparatus provided on the glove box of the vehicle but also on locking apparatuses in general.

### SUMMARY OF THE INVENTION

The invention was made in view of the problem, and an object thereof is to provide a locking apparatus which can decrease the operation noise produced at the time of unlocking to as low a level as possible and a glove box provided with the locking apparatus.

With a view to solving the problem, the gist of a first aspect of the invention resides in locking apparatus comprising:
a lid element which is displaceable between an open position and a closed position;
a locking mechanism for locking the lid element in the closed position; and
a canceling mechanism for canceling locking by the locking mechanism,
wherein the canceling mechanism includes a deformable canceling member made of a shape memory alloy and a heating device for heating the deformable canceling member, and
a canceling operation of the locking mechanism is performed by utilizing as a driving force a restoring force which is produced when shape of the deformable canceling member is restored to a memorized shape due to the deformable member being heated by the heating device.

In the configuration described above, since the deformable canceling member is made of the shape memory alloy, the shape of the deformable canceling member is restored to the memorized shape. In addition, normally, almost no noise is produced when the restoration of the memorized shape occurs. According to the configuration described above, since the restoring force produced to restore the memorized shape of the deformable canceling member when the restoration occurs is made use of as the driving force for the locking canceling operation, operation noise that is produced when canceling the locking by the locking mechanism can be decreased to as low a level as possible.

The gist of a second aspect of the invention resides in a locking apparatus according to the first aspect of the invention, wherein the heating mechanism performs its heating by energizing the deformable canceling member so as to heat the member.

According to the configuration described above, there is no need to provide separately a configuration for heating the deformable canceling member, thereby making it possible to simplify the configuration of the locking apparatus.

The gist of a third aspect of the invention resides in a locking apparatus according to the first or second aspect of the invention, wherein the deformable canceling member is formed into a linear shape, and wherein the canceling mechanism performs a canceling operation of the locking by the locking mechanism by utilizing as a driving force a restoring force which is produced to contract the deformable canceling member in a longitudinal direction when the contraction occurs.

According to the configuration described above, by forming the deformable canceling member into the linear shape and making use of the restoring force of the deformable canceling member in the longitudinal direction as the driving force for the canceling operation of the locking by the locking mechanism, a deformation quantity necessary for the locking canceling operation can be secured while decreasing a space for installation of the deformable canceling member. Namely, the deformation quantity per space necessary for installation of the deformable canceling member can be increased. In addition, by forming it into the linear shape, the volume of the deformable canceling member can be decreased so as to increase the speed at which the temperature of the deformable canceling member is raised when heated, thereby making it possible to perform quickly the locking canceling operation.

The gist of a fourth aspect of the invention resides in a locking apparatus according to the third aspect of the invention, wherein the deformable canceling member is provided in a bent-back shape.

According to the configuration described above, a larger contracting deformation force can be secured when the memorized shape of the deformable canceling member is restored while suppressing the increase in space necessary for installation of the deformable canceling member, compared to a case where the deformable canceling member is provided without being bent back.

The gist of a fifth aspect of the invention resides in a locking apparatus according to any of the first to fourth aspects of the invention, which includes a negating device for negating a locking canceling operation by the canceling mechanism by interrupting the transmission of the restoring force when the restoring force is produced by virtue of an increase in temperature of the deformable canceling member in such a state that heating by the heating device is not performed.

According to the configuration described above, since when the transmission of the restoring force of the deformable canceling member to the canceling mechanism is interrupted, no driving force is given to the canceling mechanism even though the shape of the deformable canceling member is restored to its original shape, no locking canceling operation is performed. As a result, even though the temperature of the deformable canceling member is raised by virtue of heating by other factors than the heating device, the locking mechanism can maintain the locked state with the openable and closable member kept in the closed position, thereby making it possible to avoid a risk that an unnecessary locking canceling operation is performed.

The gist of a sixth aspect of the invention resides in a locking apparatus according to the fifth aspect of the invention, wherein the locking mechanism includes a locking member for locking the lid element in the closed position, wherein the canceling mechanism is such as to cancel the locking by the locking mechanism by transmitting the restoring force to the locking member via an engagement member which is displaced together with the deformable canceling member and is brought into engagement with the locking member, and wherein the negating device displaces the engagement member to a disengagement position where the engagement member is kept disengaged from the locking member when the restoring force is produced by virtue of an increase in temperature of the deformable canceling member in such a state that heating by the heating device is not performed and displaces the engagement member to an engagement position where the engagement member is brought into engagement with the locking member when the temperature of the deformable canceling portion is decreased.

According to the configuration described above, even though the temperature of the deformable canceling member is raised by other factors than the heating by the heating device to thereby negate the locking canceling operation by the canceling mechanism, in the event that the temperature of the deformable canceling member is decreased to a level where no restoring force is produced, the restoring force of the deformable canceling member is allowed to be transmitted again to the locking mechanism. Consequently, thereafter, the locking canceling operation can normally be performed.

The gist of a seventh aspect of the invention resides in a locking apparatus according to the sixth aspect of the invention, wherein the negating device includes a deformable negating member which is made of a shape memory allow, and wherein the deformable negating member displaces the engagement member to the disengagement position where the engagement member is kept disengaged from the locking member by utilizing as a driving force a restoring force which is produced to restore its shape to a memorized shape when the restoration occurs.

In the configuration described above, in a case where the temperature of the deformable canceling member is raised by virtue of an increase in the ambient air temperature, the temperature of the deformable negating member is raised similarly. Consequently, in the event that a restoring force is produced in the deformable canceling member, a restoring force is also produced in the deformable negating member, whereby the transmission of the restoring force of the deformable canceling member to the locking mechanism is interrupted, thereby making it possible to realize the negating device through the simple configuration. Furthermore, the production of operation noise associated with the negation of the locking canceling operation by the canceling mechanism can preferably be suppressed, compared to the configuration in which the transmission of the restoring force of the deformable canceling member to the locking mechanism is interrupted by the driving force of the solenoid.

The gist of an eighth aspect of the invention resides in a locking apparatus according to the seventh aspect of the invention, wherein the deformable negating member is made of a shape memory allow having a nature that its shape is restored to a memorized shape at a lower temperature than the temperature at which the deformable canceling member is allowed to restore its memorized shape.

According to the configuration described above, since the deformable negating member produces restoring force at the lower temperature than the restoring force producing temperature of the deformable canceling member, the transmission of restoring force to the locking mechanism can be interrupted in a more ensured fashion.

The gist of a ninth aspect of the invention resides in a glove box provided with the locking apparatus set forth in any of the first to eighth aspects of the invention, which includes a storage portion having in an instrument panel of a vehicle a storage space for storing an article to be stored and an opening which makes up an entrance for the article to be stored when the article is put in the storage space for storage therein, wherein the lid element is a lid element which is provided in such a manner as to cover the opening and is adapted to be displaced between an open position where the article to be stored can be put in the storage space for storage therein and a closed position where the article to be stored cannot be put in the storage space for storage therein.

According to the locking apparatus and the glove box according to the invention, the operation noise that is produced at the time of canceling the locking by the locking mechanism can be decreased to as low a level as possible.

### BRIEF DESCRIPTION OF THE DRAWINGS

FIG. 1 is a perspective view showing an interior of a passenger compartment of a vehicle.

FIG. 2 is a perspective view showing the construction of a glove box.

FIG. 3A is a perspective view showing a locking apparatus. FIG. 3B is an exploded perspective view of the locking apparatus.

FIGS. 4A and 4B are exemplary diagrams showing operating conditions of a locking portion on a section taken along the line A-A in FIG. 1.

FIGS. 5A and 5B are operation diagrams showing the operating conditions of the locking apparatus.

### DETAILED DESCRIPTION OF THE PREFERRED EMBODIMENTS

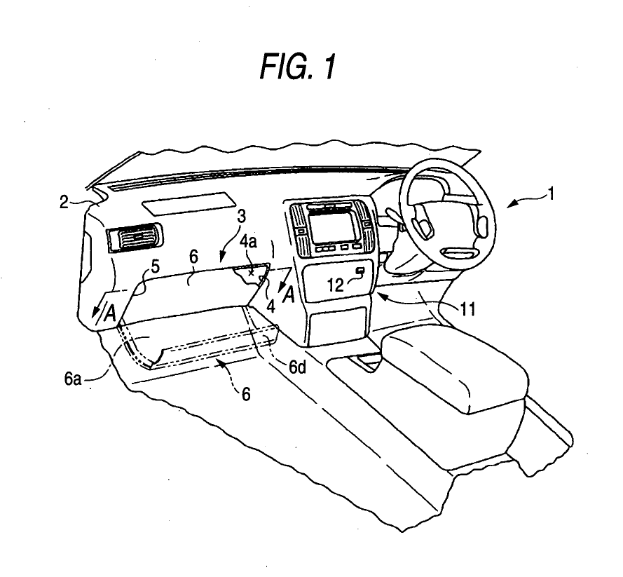

An embodiment in which a locking apparatus of the invention is applied to a glove box provided within a passenger compartment of a vehicle will be described by reference to FIGS. 1 to 5B. Note that in the following description, unless otherwise mentioned, “left,” “right,” “front,” “rear,” “up,” and “down” denote, respectively, “left,” “right,” “front,” “rear,” “up,” and “down” which result when viewed by the driver who is seated in the driver's seat of the vehicle.

FIG. 1 is a perspective view of part of an instrument panel 2 which lies in front of a front passenger's seat and a glove box 3 provided in the part of the instrument panel 2. As is shown in FIG. 1, the instrument panel 2 is provided in a passenger compartment of a vehicle in such a manner as to face the front passenger's seat and a driver's seat (both not shown), and the glove box 3 is provided in the part of the instrument panel 2 which lies in front of the front passenger's seat (not shown). This glove box 3 has a storage space 4a for storing an article to be stored and includes a box-shaped storage portion 4. In addition, an opening 5 is formed on a rear end side (a side facing the front passenger's seat) of the storage portion 4 which opens the storage space 4a towards the rear and through which an article to be stored is put in and out of the storage space 4a.

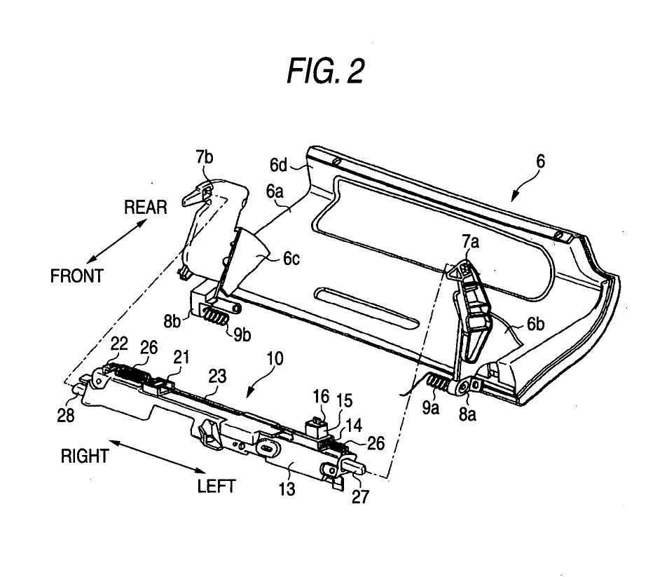

In addition, the glove box 3 includes a openable and closable lid element 6 for covering and uncovering the opening 5. As is shown in FIG. 2, the lid element 6 includes a lid portion 6a which covers the opening 5 when closed and a pair of hinge portions 6b, 6c which are provided at the front of the lid portion 6a in positions which lie slightly inwards from left and right edges of the lid portion 6a, respectively. The lid portion 6a is formed into a transversely elongated plate shape which is sized to match the size of the opening 5. In addition, a protruding portion 6d is provided along a rear end side of the lid portion 6a in such a manner as to protrude upwards therefrom.

A quadrangular engagement hole portion 7a is formed in an upper end portion of the hinge portion 6b, and a bearing portion 8a is formed at a rear end portion thereof. In addition, similar engagement portion 7b and bearing portion 8b are also formed on the hinge portion 6c. The lid element 6 is mounted rotatably at a lower end portion of the storage portion 4 via the bearing portions 8a, 8b and are constructed to rotate about the bearing portions 8a, 8b as the center of rotation. In addition, return springs 9a, 9b are mounted on the bearing portions 8a, 8b, respectively, for biasing the lid element 6 in a downward direction (a direction of opening).

Note that in the following description, a position (indicated by solid lines in FIG. 1) where the whole of the opening 5 is covered to be closed by the lid portion 6a by rotating the lid portion 6a in an upward direction (a direction of closing) is let to be a closed position. In contrast to this, a position (indicated by broken lines in FIG. 1) where the whole of the opening 5 is uncovered to be opened by rotating the lid portion 6a downwards so that the protruding portion 6d of the lid portion 6a falls towards a front seat passenger (towards the rear) is let to be an open position.

FIG. 2 is a perspective view which shows the lid element 6 and a locking apparatus 10 of the glove box 3. As is shown in FIG. 2, the glove box 3 includes the locking apparatus 10 which is formed into an elongated cylindrical shape, the locking apparatus 10 being disposed on a front side of the storage portion 4 which lies opposite to the lid element 6 across the storage space 4a (shown in FIG. 1) and extending in a transverse direction. The locking apparatus 10 is mainly made up of a locking mechanism for locking the lid element 6 which is situated in the closed position so as to restrict the movement of the lid element 6 to the open position and a canceling mechanism for canceling locking by the locking mechanism.

In addition, as is shown in FIG. 1, a push-type operating portion 12 is provided on a center panel 11 of the vehicle 1 for canceling the holding of the lid element 6 by the locking apparatus 10. A position where the operating portion 12 is provided is arranged to fall within a range where an occupant who is seated in the driver's seat (not shown) can easily operate the operating portion 12 by his or her stretched arm.

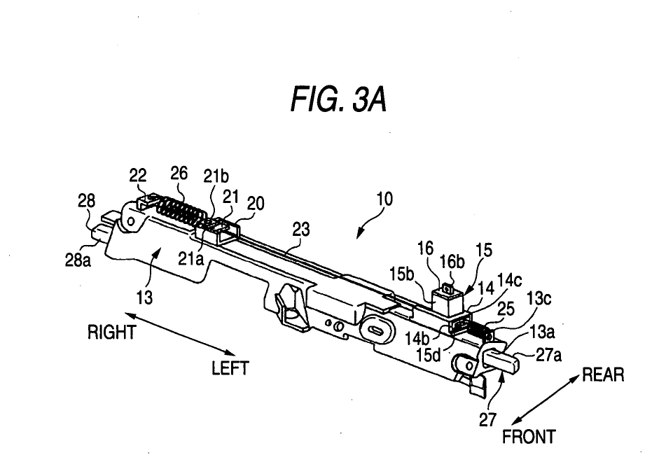

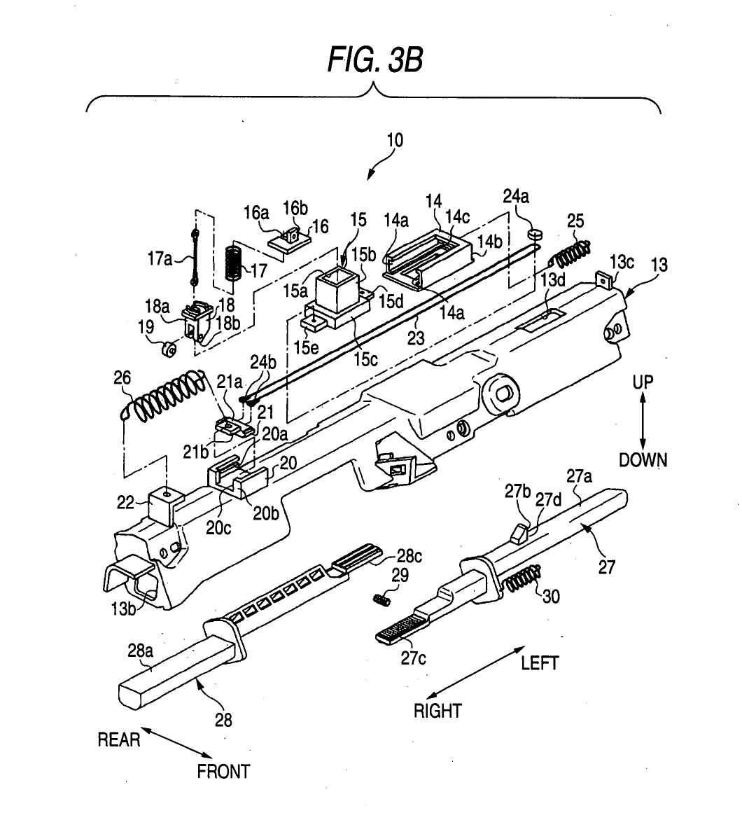

FIG. 3A is a perspective view which shows the whole locking apparatus 10, and FIG. 3B is an exploded perspective view of the locking apparatus 10. A specific configuration of the locking apparatus 10 will next be described by reference to FIGS. 3A and 3B.

As is shown in FIGS. 3A and 3B, the locking apparatus 10 includes a main body frame 13. Quadrangular locking side hole portions 13a, 13b are formed in left and right end face portions of the main body frame 13, respectively, and a holed support plate portion 13c is formed on an upper surface of the main body frame 13 at a left end thereof in such a manner as to protrude upwards. In addition, a rectangular elongated hole portion 13d is formed in the upper surface of the main body frame 13 in a position lying slightly further inwards than the holed support plate portion 13c.

A left slide base 14 is mounted on the upper surface of the main body frame 13 in a position which faces the elongated hole portion 13d in a vertical direction. The left slide base 14 has a pair of guide rail portions 14a each having a U-shaped cross section, and a laterally elongated slit 14c is formed in a left side portion 14b of the left slide base 14. A left slide portion 15 is provided on the left slide base 14 in such a state that the left slide portion 15 is slidably supported by the guide rail portions 14a. The left slide portion 15 is made up of a cylindrical portion 15b which is formed into a quadrangular cylindrical body, a sliding portion 15c which slides over the guide rail portions 14a, and a left protruding portion 15d and a right protruding portion 15e which are formed in such a manner as to protrude, respectively, leftwards and rightwards from the sliding portion 15c and which each have a hole formed therein.

In addition, a hole 15a is formed in such a manner as to pass through the cylindrical portion 15b and the sliding portion 15c. The hole 15a faces vertically the elongated hole portion 13d in the main body frame 13 in such a state that the left slide portion 15 is mounted on the left slide base 14.

In addition, the left protruding portion 15d is formed in substantially the same size as that of the slit 14c which is formed in the slide base 14. Consequently, in such a state that the left slide portion 15 slides on the slide base 14 towards the left to thereby be brought into abutment with the left side portion 14b, whereby the further leftward movement thereof is restricted, the left protruding portion 15d protrudes outwards (leftwards) from the slit 14c.

A plate-shaped cover portion 16 is mounted on the left slide portion 15 in such a manner as to cover an opening in the hole 15a on the cylindrical portion 15b. The cover portion 16 is formed in a size which matches the size of the cylindrical portion 15b and has a slit 16a which is formed in such a manner as to pass through the cover portion 16 in a vertical direction and a holed protruding portion 16b which is formed in such a manner as to protrude upwards from the cover portion 16.

In addition, an upper end of a deformable negating member 17 which is made of a shape memory alloy (nickel titanium in this embodiment) formed into a spring-like shape is connected to the holed protruding portion 16b of the cover portion 16, and the deformable negating member 17 passes through the slit 16a to be suspended in an interior of the left slide portion 15. The deformable negating member 17 has a nature that it contracts so that the shape thereof restores a memorized shape by being heated to a predetermined first temperature (70 degrees in this embodiment). In addition, since the deformable negating member 17 is formed into the spring-like shape, its variation is increased.

A substantially trapezoidal engagement member 18 is connected to a lower end of the deformable negating member 17. The deformable negating member 17 is provided in such a state that the deformable negating member 17 is pulled downward by virtue of the weight of the engagement member 18 so as to be stretched longer than the memorized shape. In addition, a support member 17a is connected to the engagement member 18, while being connected to the holed protruding portion 16b at an upper end thereof, whereby the support member 17a supports the engagement member 18. Consequently, the support member 17a prevents the deformable negating member 17 from being stretched excessively by virtue of the weight of the engagement member 18.

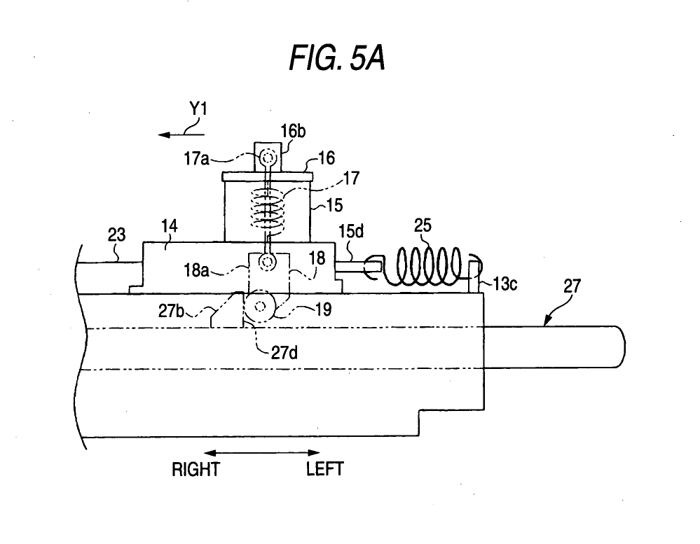

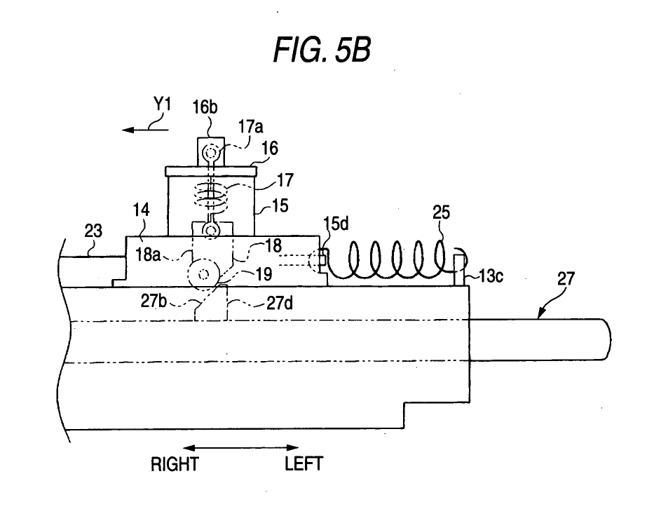

As is shown in FIG. 5A, the engagement member 18 passes through the elongated hole portion 13d formed in the main body frame 13 so as to be disposed below the upper surface of the main body frame 13 in such a state that the locking apparatus 10 is assembled properly. In addition, a roller portion 19 is provided on the engagement member 18 in such a manner as to be supported rotatably on a lower end side of the engagement member 18. The roller portion 19 is provided in such a manner that an outer circumferential edge of the roller portion 19 lies further rightwards than a right side surface 18a of the engagement member 18 and further downwards than a lower end portion 18b of the engagement member 18.

As is shown in FIGS. 3A and 3B, a right slide base 20 is mounted on the upper surface of the main body frame 13 in a position which lies slightly leftwards from a right end portion of the main body frame 13. The right slide base 20 has a pair of guide rail portions 20a, and a longitudinally central portion of a right side portion 20b is cut out so as to form a cut-out portion 20c. A right slide portion 21 is provided on the right slide base 20 in such a state that the right slide portion is slidably supported by the guide rail portions 20a. The right slide portion 21 is made up of a sliding portion 21a which slides over the guide rail portions 20a and a holed protruding portion 21b which is formed in such a manner as to protrude rightwards from the sliding portion 21a and which has a hole. Then, when the right slide portion 21 slides rightwards on the slide base 20, the holed protruding portion 21b protrudes outwards (rightwards) from the cut-out portion 20c. In addition, a support plate portion 22 having a hole in the center thereof is provided further rightwards than the right slide base 20.

A left locking portion 27 and a right locking portion 28 are provided in the interior of the main body frame 13 in such a manner as to function as locking members, respectively. The left locking portion 27 is formed into a rod-like shape and is mainly made up of a holding portion 27 which makes up a portion which holds the lid element 6, an engagement piece 27b which is formed in such a manner as to protrude from an upper surface of the holding portion 27a and a rack portion 27c on which tooth-like projections or teeth are formed. In addition, the right locking portion 28 is formed into a rod-like shape and is mainly made up of a holding portion 28a which makes up a portion which holds the lid element 6 and a rack portion 28c on which tooth-like projections or teeth are formed.

A pinion 29 is provided between the rack portions 27c, 28c, the left locking portion 27 and the right locking portion 28 are disposed in such a manner that the rack portion 27c and the rack portion 28c face each other across the pinion 29, and the rack portions 27c, 28c are brought into mesh engagement with the pinion 29. Consequently, when either of the rack portions is displaced in an axial direction, the other rack portion is also displaced by the same distance in the axial direction via the pinion 29. The left locking portion 27 and the right locking portion 28 are disposed in such a manner that the left locking portion 27 protrudes outwards (leftwards) from the locking side hole portion 13a formed in the main body frame 13 while the right locking portion 28 protrudes outwards (rightwards) from the locking side hole portion 13b formed in the main body frame 13.

A spring 30 is connected to the left locking portion 27 which biases the left locking portion 27 leftwards, whereby the left locking portion 27 is normally biased leftwards by virtue of the elastic force of the spring 30. When the left locking portion 27 is biased leftwards in this way, the biasing force which biases the left locking portion 27 in that way is converted via the pinion 29 and the rack portions 27c, 28c into a biasing force which biases the right locking portion 28 rightwards. Namely, the left locking portion 27 and the right locking portion 28 are biased by the spring 30 towards positions where they hold the lid element 6.

In addition, a deformable canceling member 23 made of a shape memory alloy (nickel titanium in this embodiment) is provided between the right protruding portion 15e of the left slide portion 15 and the sliding portion 21a of the right slide portion 21 in such a manner that left and right ends of the deformable canceling member 23 are connected to the right protruding portion 15e and the sliding portion 21a, respectively. As with the deformable negating member 17, the deformable canceling member 23 has a nature that the member contracts so that the shape thereof restores its memorized shape by being heated to a predetermined first temperature (70 degrees in this embodiment). In addition, the deformable canceling member 23 is made by forming a shape memory alloy into a linear shape and is provided in such a state that a single wire material is bent back at an intermediate point thereof.

In addition, an electrode 24a is provided on the right protruding portion 15e in such a manner as to be brought into contact with a left end portion of the deformable canceling member 23. In addition, the other electrode 24b is mounted on a right end portion of the deformable canceling member 23. These electrodes 24a, 24b are brought into connection with a battery, not shown, when the aforesaid operating portion 12 is operated, whereby a voltage is applied between the electrodes 24a, 24b so as to energize and heat the deformable canceling member 23 for a predetermined period of time (one second in this embodiment) after the operation of the operating portion 12. Namely, the deformable canceling member 23 is heated by itself by being energized. In this embodiment, the battery, the electrodes 24a, 24b and the deformable canceling member 23 function as the heating device. A left end portion of a spring 25 is connected to the holed support plate portion 13c which is formed at the left end portion of the main body frame 13, and a right end portion of the spring 25 is connected to the left protruding portion 15d which protrudes from the slit 14c. In addition, a right end portion of a spring 26 is connected to the support plate portion 22 which is provided on the right end side of the main body frame 13, and a left end portion of the spring 26 is connected to the holed protruding portion 21b which protrudes from the cut-out portion 20c. Consequently, the deformable canceling member 23 is connected indirectly with the positioning springs 25, 26 at the left and right end sides thereof. Note that the spring 25 is set such that the spring constant thereof is smaller than that of the spring 26 and is hence made to be stretched more easily than the spring 26.

To describe more specifically, in such a state that the deformable canceling member 23 does not contract, that is, the deformable canceling member 23 is stretched by forces which the member receives from the spring 25 and the spring 26, the left slide portion 15 lies in a most leftward position within its slidable range on the guide rails 14a. As this occurs, no tensile force is applied to the spring 25, and no elastic change is produced in the spring 25. On the other hand, the right slide portion 21 lies in a most rightward position within its slidable range on the guide rails 20a, and as this occurs, no tensile force is applied to the spring 26, and no elastic change is produced in the spring 26. Note that a modulus of deformation of the deformable canceling member 23 from its memorized shape in such a state is desirably made not to be excessively large from the viewpoint of extension of the life of the deformable canceling member 23, and it is desired that the modulus of deformation is preferably in the range from 1% to 7% or less.

Then, when the deformable canceling member 23 is energized to produce a restoring force therein, the deformable canceling member 23 contracts against the elastic forces of the spring 30 and the spring 25, whereby the left slide portion 15 slides rightwards over the guide rail portions 14a. In addition, when the restoring force is lost due to the energization to the deformable canceling member 23 being canceled after the contraction, the left slide portion 15 slides leftwards over the guide rail portions 14a by virtue of the elastic forces of the spring 30 and the spring 25 to thereby return to its original position.

Note that here, even in such a state that the left slide portion 15 cannot slide for some reason irrespective of the fact that the deformable canceling member 23 is attempting to contract, the tensile force being applied to the deformable canceling member 23 is mitigated by virtue of stretch of the spring 26, so as to prevent the breakage of the deformable canceling member 23.

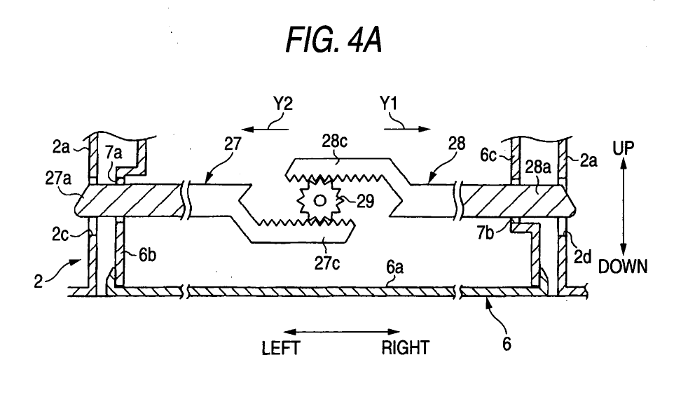

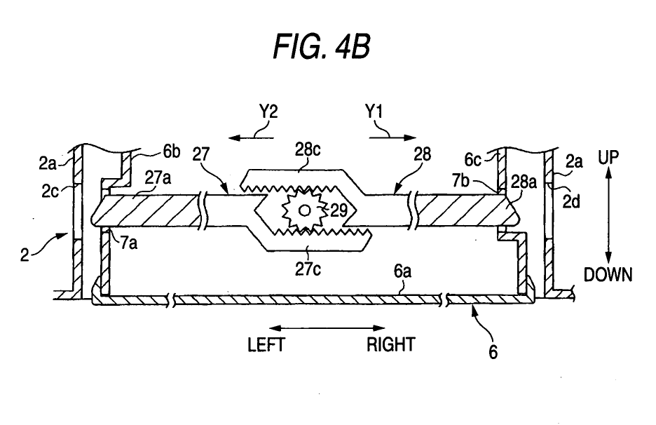

Next, a mode in which the locking apparatus 10 holds the lid element 6 and a mode in which the holding of the lid element 6 by the locking apparatus 10 is canceled will be described based on FIGS. 4 and 5. Note that in FIG. 4, for the sake of simplifying the description, other members than the locking portions 27, 28 and the pinion 29 in the locking apparatus 10 are omitted from illustration.

As is shown in FIG. 4A, in such a state that the lid element 6 is located in the closed position, the .holding portion 27a of the left locking portion 27 passes through the engagement hole portion 7a formed in the hinge portion 6b of the lid element 6 (while engaging with the engagement hole portion 7a) to be brought into engagement with a panel side engagement hole portion 2c formed in an internal wall 2a of the instrument panel 2. On the other hand, the holding portion 28a of the right locking portion 28 passes through the engagement hole portion 7b formed in the hinge portion 6c of the lid element 6 (while engaging with the engagement hole portion 7b) to be brought into engagement with a panel side engagement hole portion 2d formed in the internal wall 2a of the instrument panel 2. Consequently, even though the lid element 6 is attempted to be rotated to the open position, the rotation of the lid element 6 is restricted through the engagement of the holding portions 27a, 28a with the panel side engagement hole portions 2c, 2d, respectively, whereby the lid element 6 is not opened but is held in the closed position. Namely, in this embodiment, the engagement of the holding portions 27, 28 with the panel side engagement hole portions 2c, 2d functions to restrict the rotation of the lid element 6 as a locking mechanism.

As this occurs, in such a state that the left locking portion 27 is biased leftwards to lock the lid element 6, the engagement piece 27b of the left locking portion 27 is situated below the elongated hole portion 13d of the main body frame 13 and as is shown in FIG. 5A, a left side surface 27d of the engagement piece 27b faces and abuts the roller portion 19 of the engagement member 18. Note that the position of the engagement member 18 in this state is shown as an engagement position.

Then, when the operating portion 12 (shown in FIG. 1) is operated to cancel the holding of the lid element 6 by the locking apparatus 10, as is shown in FIG. 5A, the deformable canceling member 23 contracts in the longitudinal direction, and the left slide portion 15 slides in a direction indicated by an arrow Y1 (rightwards). Since the engagement member 18 lying in the engagement position and the roller portion 19 are also displaced in the direction indicated by the arrow Y1 in conjunction with that movement of the left side portion 15, the left locking portion 27, which has the engagement piece 27b adapted to be in engagement with the roller portion 19, is similarly displaced in the direction indicated by the arrow Y1, and as is shown in FIG. 4B, a state results in which the holding portion 27a is dislocated from the panel side engagement hole portion 2c. On the other hand, the displacement of the left locking portion 27 being propagated thereto via the pinion 29, the right locking portion 28 is displaced in a direction indicated by an arrow Y2 (leftwards) by the same distance as that over which the left locking portion 27 is displaced, whereby a state results in which the holding portion 28a is dislocated from the panel side engagement hole portion 2d. Then, in a state shown in FIG. 4B, since the lid element 6 is not held in the closed position, the lid element 6 automatically moves to the open position by virtue of biasing forces of the return springs 9a, 9b, the egress and ingress of a stored article from and in the storage space 4a being thereby enabled. Namely, in this embodiment, the deformable canceling member 23 contracts in the longitudinal direction by being energized by the electrodes 24a, 24b, and the locking portions 27, 28 are displaced so as to perform the lock canceling operation by exploiting the restoring force generated when the shape of the deformable canceling member 23 is restored to the memorized shape, whereby the deformable canceling member 23 functions as the canceling mechanism.

Incidentally, there occurs a case where the temperature in the interior of the instrument panel 2 is raised as the outside air temperature rises. In the event that the deformable canceling member 23 is heated to reach or exceed the first temperature by such a rise in the temperature inside the instrument panel 2, the deformable canceling member 23 comes to contract even though it is not energized by the electrodes 24a, 24b. As this occurs, there may be caused a risk that with the engagement member 18 lying in the engagement position, even though the occupant operates the deformable canceling member 23, the deformable canceling member 23 malfunctions to cancel the holding of the lid element 6. Because of this, as a configuration for avoiding a problem like this, the deformable negating member 17 is provided.

Namely, as is shown in FIG. 5B, when the deformable negating member 17 is heated to reach or exceed the first temperature by virtue of the rise in temperature in the interior of the instrument panel (shown in FIG. 1), the deformable negating member 17 contracts. When the deformable negating member 17 contracts, the engagement member 18, which is connected to the deformable negating member 17, is displaced upwards so as to be disengaged from the engagement piece 27b. The position of the engagement member 18 in this state is shown as a disengagement position. Since the roller portion 19 rotates while in abutment with the engagement piece 27b when the engagement member 18 is displaced upwards, the rise of the engagement member 18 is performed in a smooth fashion.

Then, since with the engagement member 18 lying in the disengagement position, the left locking portion 27 is not displace even though the deformable canceling member 23 malfunctions, the holding of the lid element 6 is not canceled. Namely, in this embodiment, in the event that the deformable canceling member 23 contracts irrespective of the fact that the member is not energized by the electrodes 24a, 24b, the engagement of the engagement member 18 with the engagement piece 27b is canceled by the deformable negating member 17 so as to interrupt the transmission of the restoring force of the deformable canceling member 23 to the locking portions 27, 28 to thereby negate the locking canceling operation, whereby the deformable negating member 17 functions as the negating device.

In addition, when the temperature in the instrument panel 2 decreases and the restoring force is generated no longer, whereby the deformable negating member 17 is restored to the stretched state, the engagement member 18 (the roller portion 19) is, as is shown in FIG. 5A, displaced to the engagement position where the engagement member 18 is brought again into engagement with the left locking portion 27 (the engagement piece 27b). Therefore, the holding of the lid element 6 can be canceled by operating the operating portion 12.

Advantages provided by the locking apparatus 10 of this embodiment that has been described heretofore will be described blow.

(1) The locking canceling operation is made to be performed by exploiting as the driving force the restoring force produced when the shape of the deformable canceling member 23 made of the shape memory alloy is restored to the memorized shape when heated. Since the deformable canceling member 23 is formed of the shape memory alloy, the shape of the deformable canceling member 23 is restored to the memorized shape when the member is heated. In addition, there occurs almost no case where noise is produced when the restoration takes place. Consequently, since the restoring force produced when the deformable canceling member 23 restores its memorized shape is made use of as the driving force of the locking canceling operation, the operation noise produced when the locking is canceled can be decreased to as low a level as possible.

(2) The deformable canceling member 23 is made to be heated by itself by being energized by the electrodes 24a, 24b. Consequently, there is no need to provide separately a configuration for heating the deformable canceling member 23, thereby making it possible to simplify the configuration of the locking apparatus 10.

(3) The deformable canceling member 23 is formed into the linear shape, and the restoring force produced when the deformable canceling member 23 contracts in the longitudinal direction is used as the driving force needed when the locking canceling operation is performed. By forming the deformable canceling member 23 into the linear shape and making use of the longitudinal restoring force of the deformable canceling member 23 as the driving force for the locking canceling operation, the necessary deformation amount for the locking canceling operation can be secured while decreasing the space necessary for the installation of the deformable canceling member 23. Namely, the deformation amount per space needed for the installation of the deformable canceling member 23 can be increased. In addition, by being formed into the linear shape, the volume of the deformable canceling member 23 can be decreased so as to increase the temperature rising rate when heated, thereby making it possible to perform the locking canceling operation quickly.

(4) The deformable canceling member 23 is made to be disposed in the bent-back shape. Consequently, compared to a case where the deformable canceling member 23 is provided without being bent back, a larger contraction deforming force can be secured when the deformable canceling member 23 restores its memorized shape while suppressing an increase in space necessary for the installation of the deformable canceling member 23.

(5) When the temperature of the deformable canceling member 23 is raised to thereby produce a restoring force in such a state that no energization is performed by the electrodes 24a, 24b, the transmission of the restoring force so produced is interrupted so as to negate the locking canceling operation that would otherwise by performed by virtue of the restoring force so produced. When the transmission of the restoring force of the deformable canceling member 23 to the locking portions 27, 28 is interrupted, even though the shape of the deformable canceling member 23 is restored to the original shape, since no driving force is given to the locking portions 27, 28, no locking canceling operation is performed. As a result, even though the temperature of the deformable canceling member 23 is raised by other factors than the energization by the electrodes 24a, 24b, the locking portions 27, 28 can keep the lid element 6 staying in the closed position so as to maintain the locked state of the lid element 6, thereby making it possible to avoid a risk that an unnecessary locking canceling operation is performed.

(6) When the temperature of the deformable canceling member 23 is raised to produce a restoring force in such a stat that no energization is performed by the electrodes 24a, 24b, the engagement member 18 is made to be displaced to the disengagement position where the engagement member 18 is kept disengaged from the engagement piece 27b (the locking portion 27). In addition, when the temperature of the deformable canceling member 23 decreases, the engagement member 18 is made to be displaced to the engagement position where the engagement member 18 is brought into engagement with the engagement piece 27b (the locking portion 27). Consequently, even though the temperature of the deformable canceling member 23 is raised by other factors than the energization by the electrodes 24a, 24b to thereby negate the locking canceling operation, in the event that the temperature of the deformable canceling member 23 decreases to such an level as no restoring force is produced, the restoring force of the deformable canceling member 23 can be transmitted again to the locking mechanism. Consequently, the locking canceling operation can be performed normally thereafter.

(7) The engagement member 18 is made to be displaced to the disengagement position where the engagement member 18 is kept disengaged from the engagement piece 27b (the locking portion 27) by exploiting as the driving force the restoring force produced when the deformable negating member 17 made of the shape memory alloy restores its memorized shape. In the event that the temperature of the deformable canceling member 23 is raised as a result of an increase in the ambient air temperature, the temperature of the deformable negating member 17 is also raised in a similar fashion. Consequently, in the event that a restoring force is produced in the deformable canceling member 23, a restoring force is also produced in the deformable negating member 17, whereby the transmission of the restoring force of the deformable canceling member 23 to the locking portions 27, 28 is interrupted, thereby making it possible to negate the locking canceling operation by the simple configuration. Furthermore, compared to a configuration where the transmission of the restoring force of the deformable canceling member 23 to the locking portions 27, 28 is interrupted by the driving force of a solenoid, the generation of operation noise in conjunction with negation can preferably be suppressed.

Note that the embodiment can be carried out in the following forms which results from appropriate modifications made to the embodiment.
The embodiment may be changed to adopt a configuration in which a solenoid or the like is used to drive the engagement member 18 as a configuration for canceling the engagement between the left locking portion 27 and the engagement member 18, and a temperature sensor is provided in the interior of the instrument panel 2 so as to activate the solenoid when the temperature reaches or exceeds the first temperature.
A configuration may be adopted in which the deformable canceling member 23 is connected directly to the left locking portion 27 (the engagement piece 27b) without the engagement member 18 interposed therebetween. As this occurs, since the engagement between the deformable canceling member 23 and the left locking portion 27 cannot be canceled, an advantage similar to those described under (1) to (5) can be provided.
As the shape memory alloy, other materials such as gold-cadmium alloy and copper-aluminum-nickel allow may be used.
The arrangement of the operating portion 12 is not limited to the center panel 11 but may be provided on, for example, the steering wheel, the gearshift lever and the like.
Different shape memory alloys may be used for the deformable canceling member 23 and the deformable negating member 17. As this occurs, a shape memory alloy which starts to contract at a lower temperature (a second temperature) than the temperature at which the deformable canceling member 23 starts to contract is preferably used for the deformable negating member 17. With this configuration, the deformable negating member 17 starts to contract before the deformable canceling member 23 is heated by the ambient temperature to start its contraction, so that the engagement between the left locking portion 27 and the engagement member 18 is canceled. Consequently, the locking between the left locking portion 27 and the engagement member 18 can be canceled in a more ensured fashion.
The locking apparatus 10 may be applied to other openable and closable portions than the glove box.

What is claimed is:

1. A locking apparatus comprising:
a lid element which is displaceable between an open position and a closed position;
a locking mechanism for locking the lid element in the closed position; and
a canceling mechanism for canceling locking by the locking mechanism,
wherein the canceling mechanism includes a deformable canceling member made of a shape memory alloy and a heating device for heating the deformable canceling member, and
a canceling operation of the locking mechanism is performed by utilizing as a driving force a restoring force which is produced when shape of the deformable canceling member is restored to a memorized shape due to the deformable member being heated by the heating device.

2. A locking apparatus according to claim 1, wherein the heating mechanism performs heating by energizing the deformable canceling member so as to heat.

3. A locking apparatus according to claim 1, wherein the deformable canceling member is formed into a linear shape, and wherein the canceling mechanism performs a canceling operation of the locking by the locking mechanism by utilizing as a driving force a restoring force which is produced to contract the deformable canceling member in a longitudinal direction when the contraction occurs.

4. A locking apparatus according to claim 3, wherein the deformable canceling member is provided in a bent-back shape.

5. A locking apparatus according to claim 1, further comprising a negating device for negating a locking canceling operation by the canceling mechanism by interrupting the transmission of the restoring force when the restoring force is produced by virtue of an increase in temperature of the deformable canceling member in such a state that heating by the heating device is not performed.

6. A locking apparatus according to claim 5, wherein the locking mechanism includes a locking member for locking the lid element in the closed position, wherein
the canceling mechanism is such as to cancel the locking by the locking mechanism by transmitting the restoring force to the locking member via an engagement member which is displaced together with the deformable canceling member and is brought into engagement with the locking member, and wherein
the negating device displaces the engagement member to a disengagement position where the engagement member is kept disengaged from the locking member when the restoring force is produced by virtue of an increase in temperature of the deformable canceling member in such a state that heating by the heating device is not performed and displaces the engagement member to an engagement position where the engagement member is brought into engagement with the locking member when the temperature of the deformable canceling portion is decreased.

7. A locking apparatus according to claim 6, wherein the negating device includes a deformable negating member which is made of a shape memory allow, and wherein the deformable negating member displaces the engagement member to the disengagement position where the engagement member is kept disengaged from the locking member by utilizing as a driving force a restoring force which is produced to restore its shape to a memorized shape when the restoration occurs.

8. A locking apparatus according to claim 7, wherein the deformable negating member is made of a shape memory allow having a nature that its shape is restored to a memorized shape at a lower temperature than the temperature at which the deformable canceling member is allowed to restore its memorized shape.

9. A glove box provided with the locking apparatus according to claim 1, comprising a storage portion having in an instrument panel of a vehicle a storage space for storing an article to be stored and an opening which makes up an entrance for the article to be stored when the article is put in the storage space for storage therein, wherein the lid element is a lid element which is provided in such a manner as to cover the opening and is adapted to be displaced between an open position where the article to be stored can be put in the storage space for storage therein and a closed position where the article to be stored cannot be put in the storage space for storage therein.
